(19) United States
(12) Patent Application Publication
(10) Pub. No.: US 2018/0367415 A1
(43) Pub. Date: Dec. 20, 2018

(54) METHOD AND APPARATUS FOR LEAST-COST COMPUTE ROUTING

(71) Applicant: Tenzar Technologies, Inc., La Jolla, CA (US)

(72) Inventor: Kevin YEDID-BOTTON, La Jolla, CA (US)

(21) Appl. No.: 16/008,816

(22) Filed: Jun. 14, 2018

Related U.S. Application Data
(60) Provisional application No. 62/520,500, filed on Jun. 15, 2017.

(51) Int. Cl. H04L 12/24; H04L 29/08

(52) U.S. Cl. CPC H04L 41/14; H04L 67/10

(57) ABSTRACT

A computing platform configured to provide low cost cloud computing may include: a backend server including: a main backend server configured to receive computing requirements; a least cost compute filter configured to comparing cost per computing unit for a plurality of compute node providers; and an infrastructure kernel configured to match the computing requirements to a compute node having a lowest cost per computing unit, and route computations to the compute node having the lowest cost per computing unit.

### CROSS REFERENCE TO RELATED APPLICATIONS

This application claims priority to U.S. Provisional Patent Application No. 62/520,500, filed Jun. 15, 2017, entitled “METHOD AND APPARATUS FOR LEAST-COST COMPUTE ROUTING” the contents of which are hereby incorporated by reference in its entirety.

### BACKGROUND

### Technical Field

This disclosure relates to systems and methods for providing low cost cloud computing.

### Related Art

Conventionally, a user that needs computing horsepower, for example, to run a machine learning program or a big data analysis pipeline, must struggle over setting up and using cloud services or buy a very expensive desktop computer. These choices are expensive in terms of both time and money.

If the user is knowledgeable enough to use the cloud, the user may choose an on-demand cloud instance in a local region to run the computations rather than engaging in the time consuming and complicated task of comparing possible compute node prices across multiple regions, multiple cloud providers, and different times. As a result, the user may spend unnecessary time and money on cloud computing.

### SUMMARY

Apparatuses and methods for providing least cost compute routing are provided.

According to various aspects there is provided a computing platform configured to provide low cost cloud computing. In some aspects, the computing platform may include: a backend server including: a main backend server configured to receive computing requirements; a least cost compute filter configured to comparing cost per computing unit for a plurality of compute node providers; and an infrastructure kernel configured to match the computing requirements to a compute node having a lowest cost per computing unit, and route computations to the compute node having the lowest cost per computing unit.

According to various aspects there is provided a method for providing low cost cloud computing. In some aspects, the method may include: receiving computing requirements; comparing cost per computing unit for a plurality of compute node providers; matching the computing requirements to a compute node having a lowest cost per computing unit; and routing computations to the compute node having the lowest cost per computing unit.

Other features and advantages should be apparent from the following description which illustrates by way of example aspects of the various teachings of the disclosure.

### BRIEF DESCRIPTION OF THE DRAWINGS

Aspects and features of the present inventive concept will be more apparent by describing example embodiments with reference to the accompanying drawings, in which:

FIG. 1 is an illustration of a block diagram illustrating compute engine architecture in accordance with various aspects of the present disclosure;

FIG. 2 is a block diagram of a computing platform in accordance with various aspects of the present disclosure;

FIG. 3 is a flowchart illustrating a process of creating and deploying a computational environment on a computing platform in accordance with various aspects of the present disclosure;

FIG. 4 is a block diagram illustrating communication paths from a client-side computing device to compute nodes in accordance with various aspects of the present disclosure;

FIG. 5 is a diagram illustrating a process of determining a lowest cost compute routing in accordance with various aspects of the present disclosure; and

FIG. 6 is a flow diagram illustrating collaboration concepts in accordance with various aspects of the present disclosure.

### DETAILED DESCRIPTION

While certain embodiments are described, these embodiments are presented by way of example only, and are not intended to limit the scope of protection. The methods and systems described herein may be embodied in a variety of other forms. Furthermore, various omissions, substitutions, and changes in the form of the example methods and systems described herein may be made without departing from the scope of protection.

Apparatuses and methods consistent with the present inventive concept provide Least Cost Compute Routing. By comparing multiple compute prices, for example in cost per compute hour, cost per compute minute, or cost per some other time unit, from across different regions and different cloud vendors, least expensive compute instances may be identified. In addition to finding the least expensive compute instances and aggregating them for users, aspects of the present disclosure handle computation, data synchronization, security, runtime environment, etc., to enable cloud computing from a desktop computer or mobile computing device.

Least-Cost Compute Routing is a process of selecting a compute node or a virtual machine (VM) in any cloud infrastructure, anywhere in the world, given a user request to compute. A user request may include the compute hardware specifications, for example, but not limited to, a number of Central Processing Units (CPUs), a number of Graphical Processing Units (GPUs), size of Random Access Memory (RAM), an operating system (OS), etc., which define the VM.

In addition to the hardware specifications, a user request may also include the user's software application content that will run on the compute node or VM. The combination of the hardware specifications and user software application content may be referred to as a computational environment (CE). A CE may be deployed to a compute node or a VM. The CE may include, for example, but not limited to, compute hardware specifications, data, code, the user's software application content, containers, configurations, OS, libraries, environments, variables, filesystems, network topographies, and any other dependencies of the user's software application.

A compute node may be a collection of available hardware and/or software resources on which a computational environment (CE) may be run. The available hardware resources may or may not all be physically co-located. Portions of the hardware and/or software of a compute node, for example, but not limited to, CPUs, memory, operating systems, etc., may be specified to form a virtual machine (VM) on the compute node for operation of the CE. In some cases, a CE may be deployed to a compute node without defining a VM.

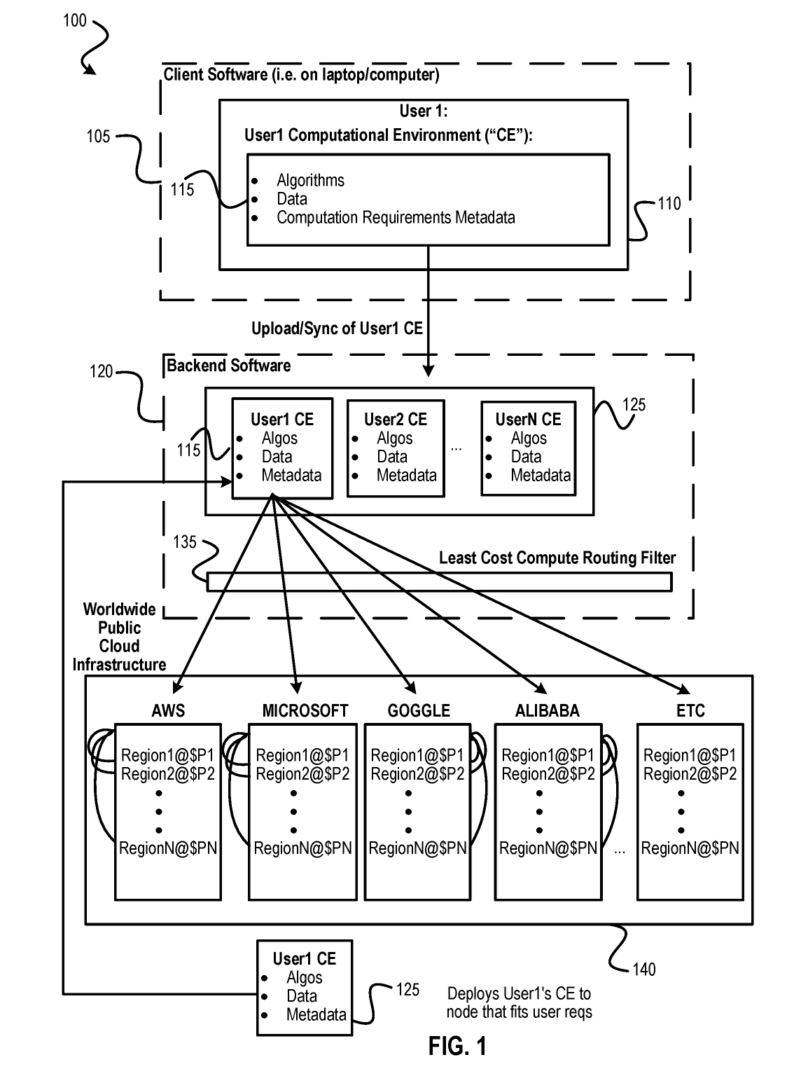

FIG. 1 is a block diagram illustrating a compute engine architecture 100 in accordance with various aspects of the present disclosure. Referring to FIG. 1, the compute engine architecture 100 may include a user computing device 105, for example, but not limited to a desktop or laptop computer or other mobile computing device, client software 110 running on the computing device 105, a backend server 120, backend software 125 running on the backend server 120, a database 130, and a least cost compute routing filter 135 running on the backend server 120. Additionally or alternatively, the client software may be a web application. Requests may be made via the client software 110 to the backend server 120 to deploy user computations on a VM or compute node in the existing worldwide public cloud infrastructure 140. In addition, compute nodes may be provided by private individuals and made available for public use.

In order to initiate a compute session (i.e., the act of requesting a compute node or VM from a cloud provider to run an arbitrary software application), a user first uploads a CE 115 from the user computing device 105 to the backend server 120. The CE 115 may be stored in the backend server 120. A user may have any number of CEs. While CEs may essentially be abstracts of a VM, the CEs may not store the base operating system image of the VM (i.e., the linux/windows OS) which are large in size (˜5 GBs-˜10 GBs), and thus save storage costs, routing bandwidth consumption, and transfer time.

Instead, the CEs may store a root filesystem (i.e., all the files, libraries, and content, without the OS) needed to run the user software application in any compute node, along with the compute hardware specifications of the VM (e.g., number of CPUs, number of CPUs CPUs, amount of RAM, etc.). One or more base machine images having a pre-configured OSs, as well as other base container images having pre-configured software packages, may be separately stored on the backend server 120.

In some cases, containers (i.e., lightweight containerized/isolated versions of VMs without the OSs) of the user's software application may be used to provider further security and operational flexibility. For example, whereas only one user's software application could run on a single VM or compute node, using a container would allow multiple software applications by isolating the runtime environments, either by the same user or different users, running on the same VM or compute node.

When a user deploys a CE representing an abstracted VM, backend software 125 may cause the backend server 120 to communicate with an existing cloud provider or any other compute infrastructure provider 140, search for a lowest possible price that matches the user's compute requirements via the least cost compute routing filter 135, and deploy the user's CE from the backend server 120 onto a compute node and/or VM of a selected provider 140. The user may seamlessly execute the software application on the VM or compute node. Through this process, time is saved in file transfer and setup in migrating the required content onto a compute node and out of a compute node, while providing the ability to maintain a “state” of the VM for a future usage.

While the VM is “live” or turned-on, costs are charged by the infrastructure provider that may be passed down to the user with an up-charge. When a user is finished running or utilizing the deployed software application in the VM, the user chooses to “sleep” or terminate the VM to stop any further costs. As a result, the user's computational environment may be unloaded from the VM. During use, or before termination, the updated filesystem of the VM may be collected by the backend server 120 and stored on the backend server 120. The updated file system may contain new content added or modifications created by the user or the backend software application 125. The backend software application 125 may synchronize the updated filesystem from the VM anywhere in the world to the main backend server 120. In that way the user may re-deploy the CE as it was last deployed, without the need to store large VMs or reconfigure the CE from scratch.

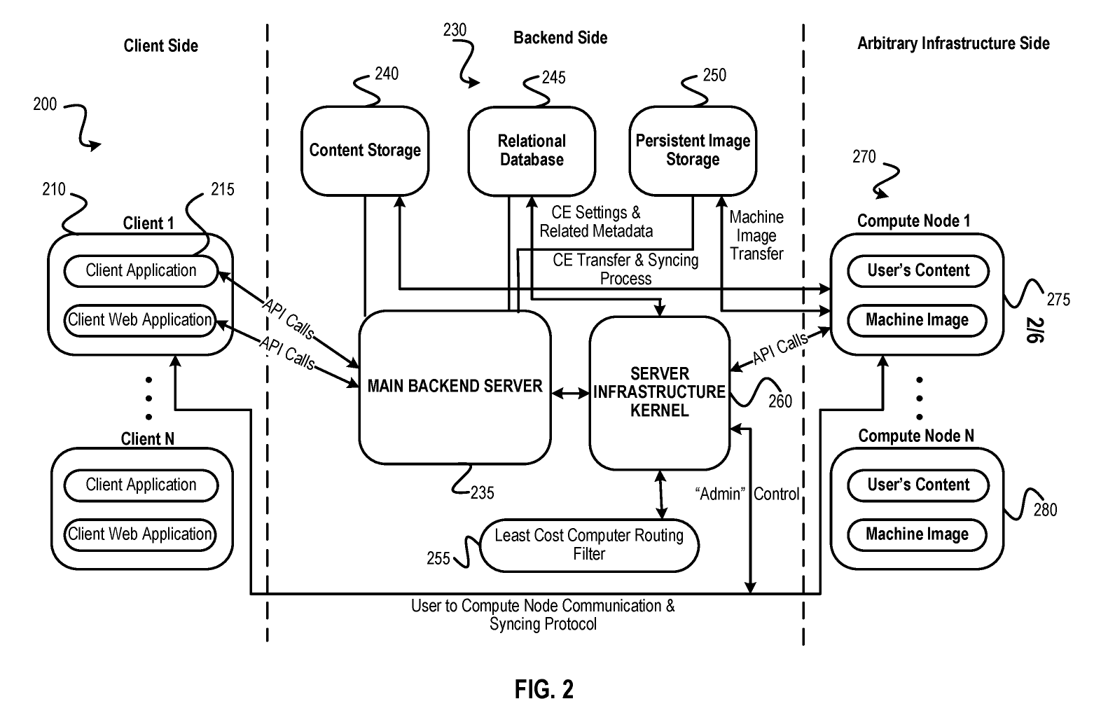

FIG. 2 is a block diagram of a computing platform 200 in accordance with various aspects of the present disclosure. Referring to FIG. 2, the computing platform 200 may include a client-side computing device 210, a backend server 230, and a cloud infrastructure 270. The cloud infrastructure 270 may include a plurality of compute nodes 275 provided by public cloud infrastructure providers. In addition, private compute nodes 280 may be provided by entities and made available for public use.

The client-side computing device 210 may be for example, but not limited to, a laptop or desktop computer, and may include the computing device hardware, an operating system (OS), and a hypervisor. The client-side computing device 210 may also include a computing engine application 215 (i.e., the client software). In accordance with various aspects of the present disclosure, the computing engine application 215 may assemble the CE based user input, for example, via a keyboard or other input device known to those of skill in the art.

The computing engine application 215 may be, for example, a command line application with the ability to upload and synchronize CEs, along with other functionalities, for example, but not limited to, cloning CEs, merging CEs, chaining CEs, etc. Alternatively, the computing engine application 215 may be a software program capable of pre-compiling CEs along with the CE requirements and dependencies into optimized software bundles that can be mounted directly on a compute node ready for execution. The computing engine application 215 may provide for communication and data exchange with the backend server 230. In accordance with various aspects of the present disclosure, the compute engine application 215 may additionally provide for communication and data exchange between the cloud infrastructure 270, individual compute nodes 275, 280, and the client-side computing device 210.

The backend server 230 may include a main backend server 235, content storage 240, a database (e.g., a relational database) 245, a persistent image storage 250, and a least cost compute routing filter 255. Operation of the backend server 230 may be controlled by a server infrastructure kernel 260. The server infrastructure kernel 260 may also be referred to throughout the disclosure as the “kernel.”

The content storage 240 may store a plurality of new and unloaded CEs from a plurality of users. A user may have any number of CEs. During use or before termination, an updated file system of the VM may be collected by the backend server 230 and stored in content storage 240 on the backend server 230 as part of the user's CE.

The database (e.g., a relational database) 245 in the backend server 230 may maintain a correspondence between each user and the user's CEs. The persistent image storage 250 may store the one or more base machine images of the VMs having pre-configured OSs and the base containers having pre-configured software packages.

The least cost compute routing filter 255 may determine the compute node on which to run a CE on a VM or compute node at the lowest available price.

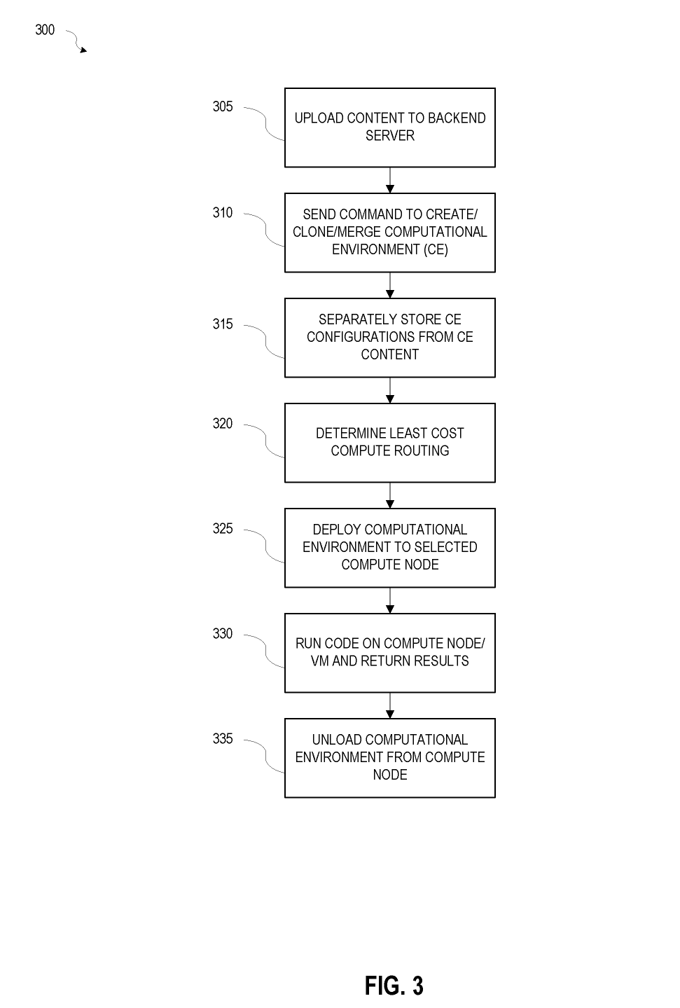

FIG. 3 is a flowchart illustrating a process 300 of creating and deploying a CE on a computing platform in accordance with various aspects of the present disclosure. Referring to FIGS. 2 and 3, a user may create a CE on a client-side computing device 210, The CE may include, compute hardware specifications, data, code, i.e., the user's software application content, containers, configurations, OS, libraries, environments, variables, filesystems, network topographies, and any other dependencies of the user's software application.

Alternatively or additionally, a computing device other than the client-side computing device 210 may control the running of the CE on a compute node or VM. The computing device controlling the running of the CE may be another local computing device or maybe a computing device running in the cloud.

The client-side computing device 210 may also include a computing engine application 215 (i.e., the client software) in accordance with various aspects of the present disclosure. The computing engine application 215 may assemble the CE based user input, for example, via a keyboard or other input device known to those of skill in the art. The computing engine application 215 may be, for example, a command line application with the ability to upload and synchronize CEs. Alternatively or additionally, the computing engine application 215 may be a software program capable of pre-compiling CEs along with the CE requirements and dependencies into an optimized software bundles that can be mounted directly on a compute node ready for execution.

At block 305, computing engine application 215 or web application may cause the client-side computing device 210 to upload content, for example, but not limited to hardware specifications and user software applications, to the backend server 230 upon receipt of an upload command or via a syncing protocol. At block 310, the computing engine application 215 or web application may send a command to backend server 230 to create a CE. For example, the computing engine application 215 or web application may send a command to create a new CE, clone an existing CE, or merge a plurality of existing CEs. At block 315, the backend server 230 may store the content of CE in a content storage device 240, for example, but not limited to, a hard disk drive. The database 245 may associate the CE and its configurations with information of a particular user. A user may have any number of CEs.

At block 320, upon receipt of a request via the local computing device 210 to deploy a specified CE, the server infrastructure kernel 260 may cause the main backend server 235 to determine a least cost compute routing. For example, a request to deploy a CE to a compute node 275 may be received from the computing engine application 215 or from the web application. In accordance with various aspects of the present disclosure, the server infrastructure kernel 260 may cause the main backend server 235 to search for and select a compute node 275 that meets the user requirements on which to run the user's CE at a lowest available price.

At block 325, the server infrastructure kernel 260 may cause the main backend server 235 to deploy the CE to the selected compute node 275 on a public cloud 270 to run the CE. At block 330, the compute node 275 may run the code specified in the CE. The server infrastructure kernel 260 may cause the compute node 275 to return the results generated by running the code specified in the CE to the backend server 230 and the backend server 230 may in turn return the results to the local computing device 210. For example, the results may be displayed on a display device of the local computing device 210. Alternatively or additionally, a user may have direct access to the compute node 275 via the computing engine application 215 or web application.

At block 335, the CE may be unloaded from the compute node 275. For example, the main backend server 235 may cause the compute node 275 to unload the CE, including any modifications made during the CE run time, and may store the unloaded CE in the content storage device 240.

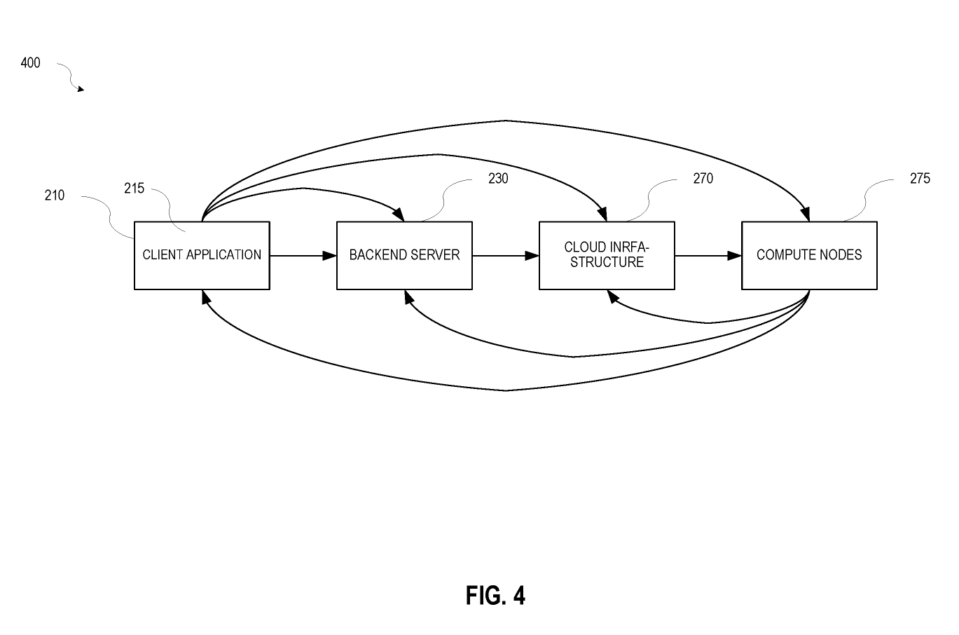

FIG. 4 is a block diagram illustrating communication paths from the client-side computing device 210 to the compute nodes 275 in accordance with various aspects of the present disclosure. Referring to FIG. 4, the client application, i.e., the computing engine application 215, running on the client-side computing device 210 may communicate with the cloud infrastructure 270 and the compute node 275 through the backend server 230, and the cloud infrastructure 270 and the compute node 275 may communicate with the client-side computing device 210 through the backend server 230.

Alternatively or additionally, the computing engine application 215 or web application running on the client-side computing device 210 may communicate directly with the cloud infrastructure 270 and/or the compute node 275 without going through the backend server 230, and the cloud infrastructure 270 and/or the compute node 275 may communicate directly with the computing engine application 215 running on the client-side computing device 210 without going through the backend server 230.

Referring again to FIG. 3, at block 340, upon receipt of a command via the local computing device 210, the server infrastructure kernel 260 may cause the backend server 230 to unload the CE from the compute node. At block 340, the backend server 230 may store the unloaded CE including any files modified on the VM or compute node during operation. The backend server 230 may store the unloaded CE in the content storage device 240. The database 245 may associate the unloaded CE with the particular user. Thus, the modified CE will be available for redeployment.

Lowest Cost Compute Routing

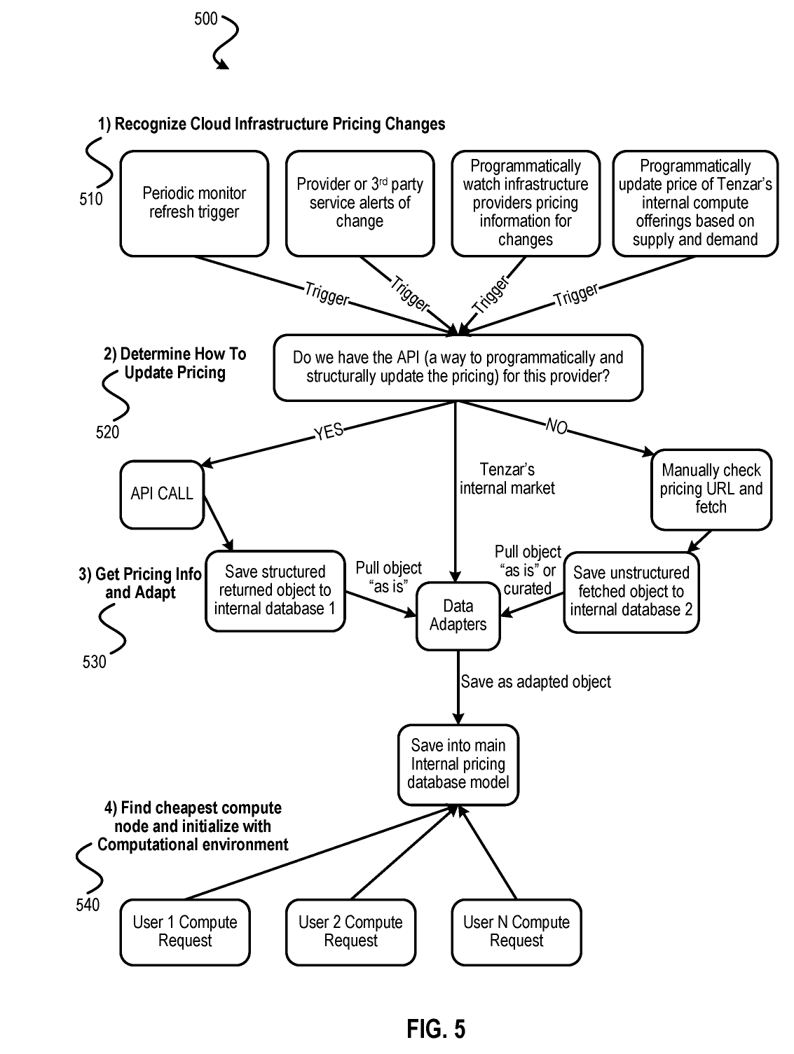

In accordance with various aspects of the present disclosure, the server infrastructure kernel 260 may select the compute node on which to run a CE at the lowest available price. FIG. 5 is a diagram illustrating a process 500 of determining a lowest cost compute routing in accordance with various aspects of the present disclosure.

With reference to FIGS. 2 and 5, in accordance with various aspects of the present disclosure, the server infrastructure kernel 260 may select via the least cost compute routing filter 255 the lowest cost compute node meeting the user requirements on which to run the user's CE. At operation 510, the server infrastructure kernel 260 may monitor computing pricing information by any of the following:
Periodically monitoring a refresh trigger;
Monitoring cloud provider or third-party service alerts of computing price changes;
Programmatically monitoring infrastructure providers pricing information for changes;
Programmatically updating internal compute price offerings based on supply and demand.

At operation 520, the server infrastructure kernel 260 may determine how to update pricing. The server infrastructure kernel 260 may determine whether and application programming interface (API) is available for a particular cloud provider. If an API is available, the server infrastructure kernel 260 may make an API call to fetch structured pricing information from the provider. If an API is not available, the pricing URL may be manually checked and unstructured pricing data fetched. Pricing URL pages may be pulled or downloaded and manually or programmatically parsed to convert unstructured pricing data to structured pricing data. Pricing data for the internal compute price offerings may be programmatically fetched. The system operator may purchase or reserve compute instances directly from infrastructure providers at a discount from the on-demand market price (e.g., by reserving or bidding for the compute instances). An internal compute market may be created having compute prices per hour lower than publicly available by the on-demand approach. The internal compute market may be available only to users of the system.

At operation 530, the server infrastructure kernel 260 may update the pricing data. The structured pricing data obtained via APIs, the manually fetched and converted unstructured pricing data, and the internal compute pricing data may be stored into a main internal pricing database in the database 245. At operation 540, when a user requests to run a CE, the server infrastructure kernel 260 may cause the least cost compute routing filter 255 to find the lowest cost compute node meeting the user requirements. The server infrastructure kernel 260 may route the user's CE to a selected lowest cost compute node.

In one example, assume that a user requests a compute node with 20 CPUs and 20 GB RAM. The system may search the internal compute pricing database for compute pricing and find that the lowest global on-demand price for this type of compute node is $2.00/hour. However, if the system operator pre-purchases or reserves compute nodes with 20 CPUs and 20 GB RAM, that were offered at a lower price, for example $1.00/hour, then the system may route the user's CE to the system's internal market created by the supply and demand of compute nodes offered by the system operator.

On the other hand, the system internal market may have no such reserved compute nodes that fit the user's specifications. In such case, the user's CE may be routed to the public cloud provider having the best available global on-demand pricing.

Collaboration

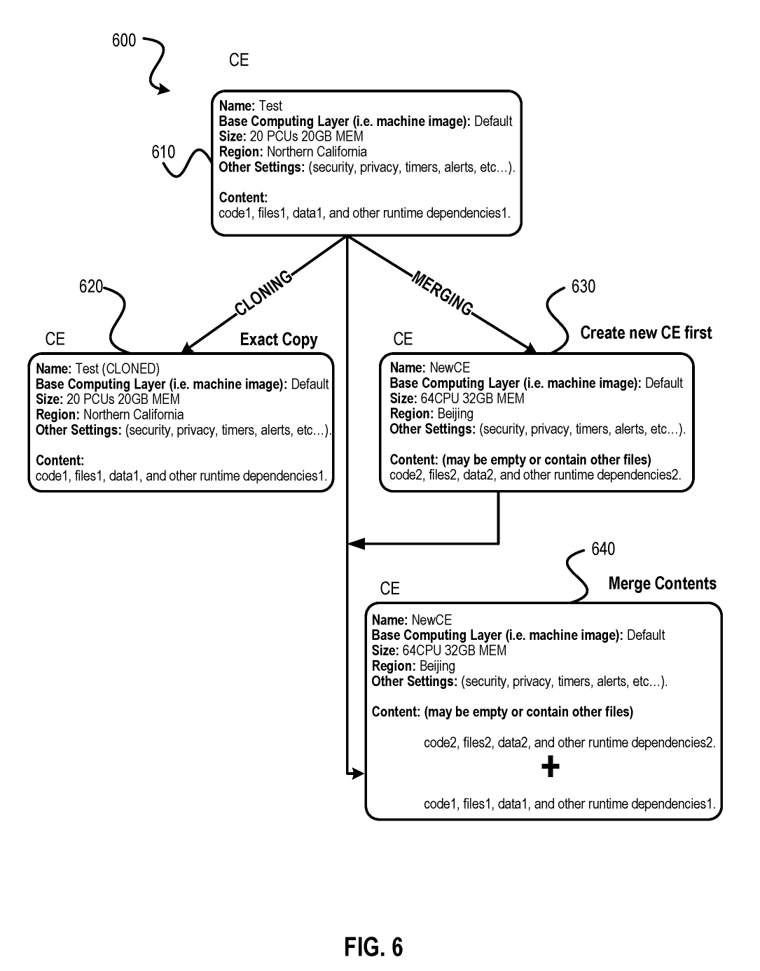

A computing platform in accordance with the present disclosure may support several types of collaboration concepts based on the described processes of abstracting VMs: cloning, merging, and chaining. FIG. 6 is a flow diagram illustrating collaboration concepts 600 in accordance with various aspects of the present disclosure. Referring to FIG. 6, at block 610, a CE may be generated. At block 620, the CE may be cloned. A cloning command may create an identical copy of a CE (i.e., including all content, configurations, specs, metadata, etc.). A user who clones a CE owns that cloned CE. The owner of the cloned CE may also grant permission to other users to work with the cloned CE.

In accordance with various aspects of the present disclosure, CEs may also be merged. At block 630, a second destination CE may be configured and created. At block 640, a merge command may merge/transfer the content of the source CEs without the configurations into the second destination CE. The second destination CE contains its own configurations but receives the content of the source CE.

In accordance with various aspects of the present disclosure, CEs may also be chained. Chaining CEs directly “hooks up” different independent CEs into a work-flow of CE's each fulfilling a different function. Chaining of CEs may provide similar additive properties such that interpedently X, Y, Z, . . . N, would together operate as X+Y+Z+ . . . +N for a workflow of added CEs. For example, CE X may read data, CE Y may analyze data, and CE Z may transform data. A workflow of read→analyze→transform may be created without manually adapting the underlying software, but instead by chaining CE X+CE Y+CE Z.

Additional users may be permitted to work with and/or modify CEs that have been cloned, merged, and/or chained, thus providing spaces for collaboration.

Real-time Synchronization

Real time synchronization of content changes between the local computing device 210 to a deployed CE transforms discrete, step-wise, operations of controlling file transfers, authentication protocols, and related cloud computing infrastructure operations, into a continuous process (i.e., all files and requirements continuously synchronized/uploaded/moved, etc.). In accordance with various aspects of the present disclosure, with real time synchronization the client-side installed software may include a synchronizing protocol that synchronizes content (i.e., a CE) from a local computing device 210 up to backend server 230. The client-side installed software may pre-compile the CE. A compute node 275 may also include a similar version of the synchronizing protocol that would synchronize the content from the compute node back to the backend server 230.

Marketplace

In accordance with various aspects of the present disclosure, a marketplace may be provided to enable users to develop software applications, upload them to the marketplace, and permit users to install them into their accounts. The marketplace may be a part of the main backend server 230, and may enable registered individuals and organizations to publish their CEs so that other people can use them for a variety of tasks without having to worry about maintain infrastructure.

For example, software developer A may build a CE that filters photos. The CE cannot run on a typical phone or computer because its sort filter requires a lot of computing power. Software developer A publishes the CE on the computing platform to run on a large size compute node. When user B uses the photo filter CE, user B can either “clone or merge or chain or ‘install’) the photo filter CE into her account and add her own photos to be filtered. Software developer A is therefore not in charge of the compute node. The CE may be bundled with the abstracted VM so that when user B installs the CE, she now also owns an abstracted VM that can be run at any scale at any time. User B is responsible for the costs of her own abstracted VM running the CE. Thus, user B may run very powerful apps without having to install them into her computer or local device.

While certain embodiments have been described, these embodiments have been presented by way of example only, and are not intended to limit the scope of the protection. The methods and systems described herein may be embodied in a variety of other forms. Various omissions, substitutions, and/or changes in the form of the example methods and systems described herein may be made without departing from the spirit of the protection.

The accompanying claims and their equivalents are intended to cover such forms or modifications as would fall within the scope and spirit of the protection. For example, the example systems and methods disclosed herein can be applied to hard disk drives, hybrid hard drives, and the like. In addition, other forms of storage, for example, but not limited to, DRAM or SRAM, battery backed-up volatile DRAM or SRAM devices, EPROM, EEPROM memory, etc., may additionally or alternatively be used. As another example, the various components illustrated in the figures may be implemented as software and/or firmware on a processor, ASIC/FPGA, or dedicated hardware. Also, the features and attributes of the specific example embodiments disclosed above may be combined in different ways to form additional embodiments, all of which fall within the scope of the present disclosure.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A computing platform configured to provide low cost cloud computing, the computing platform comprising:
a backend server including:
a main backend server configured to receive computing requirements;
a least cost compute filter configured to comparing cost per computing unit for a plurality of compute node providers; and
an infrastructure kernel configured to match the computing requirements to a compute node having a lowest cost per computing unit, and route computations to the compute node having the lowest cost per computing unit.

2. The computing platform of claim 1, wherein the backend server is further configured to receive a computational environment (CE),
wherein the CE comprises the computing requirements and software application content.

3. A method for providing low cost cloud computing, the method comprising:
receiving computing requirements;
comparing cost per computing unit for a plurality of compute node providers;
matching the computing requirements to a compute node having a lowest cost per computing unit; and
routing computations to the compute node having the lowest cost per computing unit.

4. The method of claim 3, wherein the computing requirements are received as part of a computational environment (CE), and
wherein the CE further includes software application content.
